(19) United States
(12) Patent Application Publication
(10) Pub. No.: US 2026/0163259 A1
(43) Pub. Date: Jun. 11, 2026

(54) CLAMP RETAINER, ELECTRIC CONNECTOR AND MANUFACTURING METHOD

(71) Applicant: TE Connectivity India Private Limited, Bangalore (IN)

(72) Inventors: Gururaj SETTRU, Bangalore (IN); Ravi Molakalmuru RAGHAVENDRA, Bangalore (IN); Prashanth SURATHKAL, Bangalore (IN); Ankith RAMESH, Bangalore (IN); Dinesh Kumar SRINIVASAN, Bangalore (IN); Subhasree SAHOO, Bangalore (IN)

(21) Appl. No.: 19/259,249

(22) Filed: Jul. 3, 2025

(30) Foreign Application Priority Data
Jul. 3, 2024 (EP) 24186340.6

(51) Int. Cl. H01R 4/48; H01R 43/20

(52) U.S. Cl. CPC H01R 4/48185; H01R 43/20

(57) ABSTRACT

A clamp retainer for an electric connector includes an insulation housing defining at least one receptacle for inserting an electrical conductor along an insertion direction, and at least one clamping spring for clamping the electrical conductor upon insertion into the at least one receptacle, wherein the at least one clamping spring comprises a fixing portion, a clamping portion and an intermediate portion, wherein the fixing portion is held directly by the insulation housing, wherein the clamping portion is deflectable towards the fixing portion, wherein the clamping portion and the fixing portion are jointed by the intermediate portion, and wherein the intermediate portion is spaced apart from the insulation housing in the insertion direction.

### CROSS REFERENCE TO RELATED APPLICATIONS

This application claims the benefit of EP Application No. 24186340.6, filed 3 Jul. 2024, the subject matter of which is herein incorporated by reference in its entirety.

### BACKGROUND OF THE INVENTION

The subject matter herein relates to a clamp retainer for an electric connector as well as an electric connector with such a clamp retainer. Further, the subject matter herein relates to a method for manufacturing such a clamp retainer.

In many industrial applications, complex automation systems are utilized that require transmitting electrical currents and/or signals between a multitude of system components. Herein, it is equally important to establish all connections between the system components in a reliable manner with minimal costs and effort.

Electric connectors with clamp retainers are especially suitable for such a purpose, since they allow an electrical connection to be established simply by inserting bare ends of conductive wires and other types of electrical conductors into the clamp retainers.

As with most technologies, there is a continued need for innovative solutions that stream-line electrical connection processes while maintaining high levels of performance, reliability, and cost-effectiveness.

There is a need to provide low-cost and low-effort means for establishing electrical connections in a reliable way.

### BRIEF DESCRIPTION OF THE INVENTION

In an embodiment, a clamp retainer for an electric connector is provided including an insulation housing defining at least one receptacle for inserting an electrical conductor along an insertion direction, and at least one clamping spring for clamping the electrical conductor upon insertion of the electrical conductor into the at least one receptacle, wherein the at least one clamping spring comprises a fixing portion, a clamping portion and an intermediate portion, wherein the fixing portion is held directly by the insulation housing, wherein the clamping portion is deflectable towards the fixing portion, wherein the clamping portion and the fixing portion are jointed by the intermediate portion, and wherein the intermediate portion is spaced apart from the insulation housing in the insertion direction.

The electrical conductor may be a lead wire or a hook-up wire of the electric connector, for example a stranded wire or a solid wire. Other possible types of the electrical conductors include conductive braids, tubes and tapes as well as busbars. The electrical conductor may be made of copper, aluminum or other metals.

The above solution is advantageous for the following reasons.

Directly holding the clamping spring with the insulation housing allows intermediate holding structures such as cages and frames that are common in known retainers, to be omitted. That is, the fixing portion of the at least one clamping spring and the insulation housing are at least sectionally in immediate contact with no other parts in between them. This not only saves material costs, but also shortens the assembly time of the present clamp retainer due to the lower number of parts.

Moreover, by spacing the intermediate portion from the insulation housing, the clamping spring is cantilevered and provided with a certain clearance, in which the intermediate portion can move without being obstructed by the insulation housing. This can help to better compensate vibrations as well as other unwanted movements effecting the clamp retainer, while offering the same clamping force as springs in known retainers. In other words, the clamping spring is equally strong, but less rigid compared to known retainers where the spring rests against the housing, cage or frame in the insertion direction. This improves the performance and reliability of the present clamp retainer.

The above clamp retainer may further be improved by any of the features, which are described in the following. The features may be used in any combination. Each of the following features is independent of the other features and advantageous on its own.

According to one possible embodiment with low production costs, the at least one clamping spring may be a single-piece, continuous metal component manufactured by stamping and/or bending a sheet of spring steel or other suitable metal. Alternatively, the at least one clamping spring may also be made of non-metallic materials with higher elasticity than the insulation housing. On the other hand, the insulation housing may be made of a non-conductive material, in particular a material with a conductivity of less than 10\hat{ }−8 S·cm\hat{ }−1 and/or a specific resistance over 10\hat{ }8 Ω·cm. For example, the insulation housing may be made of plastic, ceramic and/or other non-metallic materials.

To arrive at a simple design, the at least one clamping spring may be substantially V-shaped with two legs formed by the clamping portion and the fixing portion, respectively. The clamping portion and the fixing portion may be jointed by the intermediate portion at an angle. In other words, the intermediate portion may extend between the clamping portion and the fixing portion at least sectionally in a bent, curved, folded and/or angular manner. Other sections of the intermediate portion may be straight. In particular, the intermediate portion may be bent, curved and/or folded away from the clamping portion and the fixing portion. Optionally, the at least one clamping spring may consist of the fixing portion, the clamping portion and the intermediate portion.

The at least one clamping spring may be configured to automatically clamp the electrical conductor upon its insertion into the at least one receptacle. In particular, the at least one clamping spring may be configured to stem against the inserted electrical conductor and prevent the electrical conductor from being pulled out contrary to the insertion direction. This facilitates the insertion process of the electrical conductor.

In particular, the clamping portion may be substantially straight and/or may extend obliquely to the insertion direction into the at least one receptacle. For example, the clamping portion may be inclined by an angle of 30° to 50° relative to the insertion direction. This configuration allows the electrical conductor to be easily moved relative to the clamping portion in the insertion direction. On the other hand, if the electrical conductor is moved relative to the clamping portion against the insertion direction, the clamping portion stems against the electrical conductor. This impedes the latter movement, which could be caused e.g., by a tensile load applied to the electrical conductor against the insertion direction. In other words, the clamping portion may be configured to engage in a self-locking, mechanical connection with the electrical conductor. Due to the self-locking nature of this engagement, the electrical conductor can simply be inserted into the at least one receptacle with minimal effort.

As already described, the clamping portion is deflectable towards the fixing portion and may also be deflectable away from the fixing portion. Optionally, the clamping portion may be freely deflectable towards the fixing portion into abutment with the insulation housing and away from the fixing portion. In other words, the clamping portion may be deflected towards the fixing portion into abutment with the insulation housing and back without its movement path being obstructed. Alternatively, a trigger mechanism may be provided that catches the clamping portion in its deflected state. Upon insertion of the electrical conductor and/or activation of a button, the trigger mechanism may release the clamping portion to spring under its restoring force away from the fixing portion. Thereby, the clamping spring may be configured to automatically clamp the electrical conductor upon insertion. The trigger mechanism may be spring-loaded.

According to a further embodiment, the insulation housing may comprise at least one holding slot for holding the fixing portion of the at least one clamping spring. In particular, the fixing portion of the at least one clamping spring may be inserted into the at least one holding slot. This represents a simple way to achieve the direct holding of the at least one clamping spring by the insulation housing. Similar to the at least one receptacle, the at least one holding slot may extend through the insulation housing. In particular, the at least one holding slot may lead into the at least one receptacle.

An inner contour of the at least one holding slot may be complementary at least sectionally with an outer contour of the fixing portion of the at least one clamping spring. Herein, the contours are complementary if they coincide or correspond to each other within a margin of +/−10%. In other words, the fixing portion of the at least one clamping spring at least fills out 90% of the at least one holding slot or is oversized up to not more than 110%.

In order to provide a certain flexibility during the manufacturing process of the clamp retainer, the at least one holding slot may be accessible from the insertion direction and/or from a direction perpendicular to the insertion direction. Depending on the surrounding geometric conditions, the fixing portion of the at least one clamping spring may thus be inserted into the at least one holding slot along the insertion direction.

For this, the fixing portion may be substantially straight. Moreover, the fixing portion may be configured to withstand a force pulling it out of the at least one holding slot. For example, the fixing portion may comprise a barbed section configured to engage in an interference-fit connection with the insulation housing. In particular, the barbed section may comprise teeth and/or latching features that engage with an inner surface of the at least one holding slot, when the barbed section is inserted there into. In other words, the fixing portion may be quickly and securely stitched into the insulation housing in an irreversible manner.

Alternatively or additionally, the fixing portion may be inserted into the at least one holding slot perpendicularly to the insertion direction if the geometric conditions of the surrounding require it to do so. In this case, the at least one holding slot may comprise an undercut in the insertion direction. In other words, the at least one holding slot may extend through the insulation housing perpendicularly to the insertion direction and form a recess in the insulation housing that is inaccessible using a straight tool directed in the insertion direction. By inserting the fixing portion of the at least one clamping spring perpendicular to the insertion direction, however, the fixing portion can enter into the undercut. There, the fixing portion can rest against the insulation housing and withstand a force, pulling it out of the at least one holding slot.

This allows the fixing portion to engage in a reliable form-fit connection with the insulation housing that optionally can be reversible. For example, the fixing portion of the at least one clamping spring may comprise a hook-shaped section configured to engage in said form-fit connection with the insulation housing, specifically with the undercut of the at least one holding slot. At the hook-shaped section, the otherwise straight fixing portion may be bent backwards and may extend in parallel with another section of the fixing portion adjacent to the hook-shaped section, substantially resulting in a shape similar to the letter “J”.

If multiple clamping springs are provided, the insulation housing may comprise one holding slot of each clamping spring. Alternatively, one or more clamping springs may share the same holding slot.

According to a further possible embodiment, the manufacturing process of the clamp retainer may be facilitated by providing the insulation housing as a multi-part assembly. In particular, the insulation housing may comprise at least one housing element forming the at least one receptacle and/or the at least one holding slot. Further, the insulation housing may comprise at least one cover element attachable to the at least one housing element.

Thus, the at least one clamping spring can first be fixed in the at least one holding slot, whereafter the at least one cover element can be attached to shut the at least one receptacle. Optionally, the at least one cover element may be aligned with the at least one clamping spring in the insertion direction. To insert the electrical conductor, the at least one cover element may comprise an opening which leads into the at least one receptacle. In order to cantilever the at least one clamping spring, the at least one cover element may be spaced apart from the intermediate portion of the at least one clamping spring.

Optionally, the clamp retainer may comprise at least one push-button element slidably held by the at least one cover element. The at least one push-button element serves to facilitate the operation of the clamp retainer. For example, the at least one push-button element may be movable into a release position, where the at least one push-button element is configured to deflect the clamping portion of the at least one clamping spring away from the clamped electrical conductor. This way, removal of the electrical conductor requires less effort.

Likewise, the at least one push-button element may be configured to deflect, in the release position, the clamping portion towards the corresponding fixing portion and thus make room for the electrical conductor in the at least one receptacle. Moreover, the at least one push-button element may be movable between the release position and an engagement position. In the engagement position, the at least one push-button element allows the clamping portion to clamp the electrical conductor. Optionally, the at least one push-button element may be pushed by the at least one clamping spring out of the release position and into the engagement position. Thereby, the electrical conductor can be clamped by simply letting go of the at least one push-button element.

According to a further possible embodiment, the insulation housing may comprise a single integral housing element which forms a plurality of receptacles, each used for inserting a different electrical conductor. Thereby, the clamp retainer can be used in electric connectors with multiple electrical conductors.

Alternatively, the insulation housing may comprise a plurality of modular housing elements, each forming a receptacle for inserting a different electrical conductor. The modular housing elements may be stackable in a sense that they are configured to be stacked onto each other or next to each other. This way, the clamp retainer can be used not only in electric connectors with multiple electrical conductors, but also with varying numbers of electrical conductors.

Optionally, each of the modular housing elements may comprise at least one attachment feature on a lateral side thereof and at least one counterpart attachment feature that is complementary to the at least one attachment feature and arranged opposite of the lateral side. For increased stability and redundancy, two attachment features may be provided on the lateral side and two counterpart attachment features may be correspondingly arranged opposite the lateral side. Herein, the lateral side may be a side extending parallel to the insertion direction.

Each attachment feature may be configured to engage in a form-fit connection with the corresponding counterpart attachment feature of an adjacent housing element. This way, the stackability of the modular housing elements can be easily achieved.

For example, each modular housing element may have a substantially cuboid shape that is open from the insertion direction and/or from the direction perpendicular to the insertion direction. In other words, an outer wall of the cuboid shape may be omitted on a top side and/or on the lateral side of each modular housing element. Herein, the top side may be a side extending perpendicular to the insertion direction.

Moreover, all modular housing elements may be stacked adjacent to each other with the open sides (i.e. the open top sides and/or the open lateral sides) facing in the same direction, respectively. The open top sides of the modular housing elements may be closed by the at least one cover element. Optionally, a side plate may be provided for closing the open lateral side of the outermost modular housing element. In other words, the side plate may replace the omitted outer wall of the outermost modular housing element. Similar to the modular housing elements, the side plate may comprise one or more counterpart attachment features.

In order to provide the clamp retainer with a structural stability comparable to a known retainer with a metal cage, the insulation housing may comprise at least one reinforcement structure extending along the insertion direction. In particular, the at least one reinforcement structure may be a stiffening rib extending along the lateral side.

In the embodiment of the clamp retainer comprising the at least one attachment feature, the at least one reinforcement structure may form the least one attachment feature. In particular, the at least one reinforcement structure embodied by the stiffening rib may be shaped complementary to the at least one counterpart attachment feature. In this case, the at least one counterpart attachment feature may be configured as a receiving groove that extends along the insertion direction and receives the stiffening rib.

In other words, the at least one reinforcement structure functioning as the at least one attachment feature and the at least one counterpart attachment feature may be configured to engage in the above-mentioned form-fit connection. This functional integration results in a compact clamp retainer.

In particular, the stiffening rib may comprise a T-shaped profile, while the receiving groove has a hollow T-shape and is accessible from the insertion direction. The above-mentioned form-fit connection between the rib-shaped attachment feature and the groove-shaped counterpart attachment feature is then established by moving the modular housing elements relative to each other along the insertion direction and thus sliding the T-shaped profile into the hollow T-shaped groove.

Alternatively, each attachment feature may be embodied by a cylindrical nob that projects from the lateral side of the respective modular housing element. For example, the cylindrical nob may extend in the direction perpendicular to the insertion direction. Accordingly, each counterpart attachment feature may be embodied by a round hole configured to engage in a press-fit connection with the cylindrical nob. Said press-fit connection is advantageously established by moving the modular housing elements relative to each other along the direction perpendicular to the insertion direction. This means that pull-out forces acting on the electrical conductor in the insertion direction cannot disengage the connection between the respective modular housing elements.

If multiple attachment features and counterpart attachment features are provided, a coding function can be implemented. For example, at least one pair of cylindrical nob and round hole could be sized differently from the other cylindrical nobs and round holes. Of course, the nobs and holes do not have to be cylindrical and round, respectively, as long they have mutually complementary shapes that allow their press-fit connection.

The object defined in the outset can also be achieved by an electric connector comprising a clamp retainer according to any one of the above-described embodiments. Further, the electric connector may comprise at least one electrical conductor as described above as well as at least one contact element. The at least one contact element may be for example a contact rail consisting of or comprising a metal strip. The at least one contact element may be a stamped and bent part made of copper, aluminum or other metals.

The electric connector benefits from the technical effects and advantages of the clamp retainer as explained above. In particular, the electric connector exhibits an improved resistance against vibrations and other unwanted movements that would otherwise deteriorate its performance and reliability.

Similar to the at least one clamping spring, the at least one contact element may be directly held by the insulation housing of the clamp retainer. For this purpose, the insulation housing may comprise at least one rail slot configured to receive the at least one contact element. In particular, an inner contour of the at least one rail slot may be complementary at least sectionally with an outer contour of the at least one contact element.

The at least one clamping spring and the at least one contact element both may be inserted into their respective slot (i.e. holding slot or rail slot) along the insertion direction. Alternatively, the at least one clamping spring and the at least one contact element may be inserted into their respective slot from opposite directions or mutually perpendicular directions.

Moreover, the at least one contact element may be configured to contact the at least one electrical conductor when the latter is inserted into the clamp retainer. For this purpose, a contacting surface of the at least one contact element may be exposed in the at least one receptacle in order to contact the at least one electrical conductor.

Optionally, the at least one rail slot may be arranged opposite to the at least one holding slot with respect to the at least one receptacle. Accordingly, the at least one electrical conductor may be inserted into the at least one receptacle of the insulation housing and clamped between the at least one contact element and the at least one clamping spring. In the clamped state, the clamping portion of the at least one clamping spring may extend obliquely towards the at least one electrical conductor in order to achieve the above-mentioned self-locking, mechanical connection.

The object defined in the outset can also be achieved by a method for manufacturing a clamp retainer for clamping an electrical conductor of an electric connector, wherein the clamp retainer is manufactured from at least one clamping spring comprising a fixing portion and a clamping portion jointed by an intermediate portion and an insulation housing comprising at least one receptacle for inserting the electrical conductor along an insertion direction, wherein the method comprises the step of fixing the at least one clamping spring at its fixing portion directly to the insulation housing such that the clamping portion is deflectable towards the fixing portion and the intermediate portion is spaced apart from the insulation housing in the insertion direction.

Advantageously, the above method may be used to manufacture a clamp retainer according to any one of the above-described embodiments. Therefore, the method provides the technical effects and advantages of the clamp retainer as explained above.

During the above method step of fixing, the at least one clamping spring may be placed into the insulation housing along the insertion direction. This is advantageous, since the clamping spring and, later on, the at least one electrical conductor share the same insertion direction. Accordingly, the insulation housing requires accessibility from one side only.

Alternatively, the at least one clamping spring may be placed into the insulation housing perpendicular to the insertion direction, during the above fixing step. Thereby, a more secure fixation of the at least one clamping spring is possible, e.g. through utilization of the above-mentioned undercut in the insulation housing.

In the following, exemplary embodiments are described with reference to the figures. In the figures, the same reference numerals are used for elements that correspond to one another in terms of their function and/or structure. As described above, an element of an embodiment can be omitted if its technical effects is not needed for a particular application, and vice versa: an element that is not part of a specific embodiment may be added if its technical effect is advantageous in a specific application.

### BRIEF DESCRIPTION OF THE DRAWINGS

The invention shall be explained in more detail hereafter by way of example with reference to the drawings. The feature combinations illustrated in the embodiments shown by way of example can be supplemented by further features in accordance with the above statements in correspondence with the properties of the invention required for a specific application. Individual features can also be omitted in accordance with the above statements from the embodiments described if the effect of these features is of no relevance for a specific application. The same reference numerals in the drawings are always used for elements having the same function and/or the same structure.

FIG. 1 shows a schematic sectional side view of an electric connector according to an exemplary embodiment;

FIG. 2 shows a schematic sectional side view of the electric connector according to another exemplary embodiment;

FIG. 3 shows a detailed schematic sectional view along the line III-III shown in FIG. 2;

FIG. 4 shows a schematic perspective illustration of a clamp retainer according to an exemplary embodiment in an exploded view;

FIG. 5 shows another schematic perspective illustration of the clamp retainer from FIG. 4;

FIG. 6 shows another schematic perspective illustration of the clamp retainer from FIG. 4;

FIG. 7 shows a schematic perspective illustration of the electric connector from FIG. 1 in an exploded view;

FIG. 8 shows a schematic perspective illustration of the electric connector from FIG. 2 in an exploded view;

FIG. 9 shows a schematic perspective illustration of the electric connector according to another exemplary embodiment in an exploded view;

FIG. 10 shows a schematic illustration of the assembled electric connector from FIG. 9 in a top view;

FIG. 11 shows a schematic perspective illustration of a detail of the electric connector from FIG. 9;

FIG. 12 shows another schematic perspective illustration of the detail from FIG. 11;

FIG. 13 shows a schematic perspective illustration of the electric connector according to another exemplary embodiment in an exploded view; and

FIG. 14 shows a schematic perspective illustration of a detail of the electric connector from FIG. 13 in a sectional view.

### DETAILED DESCRIPTION OF THE INVENTION

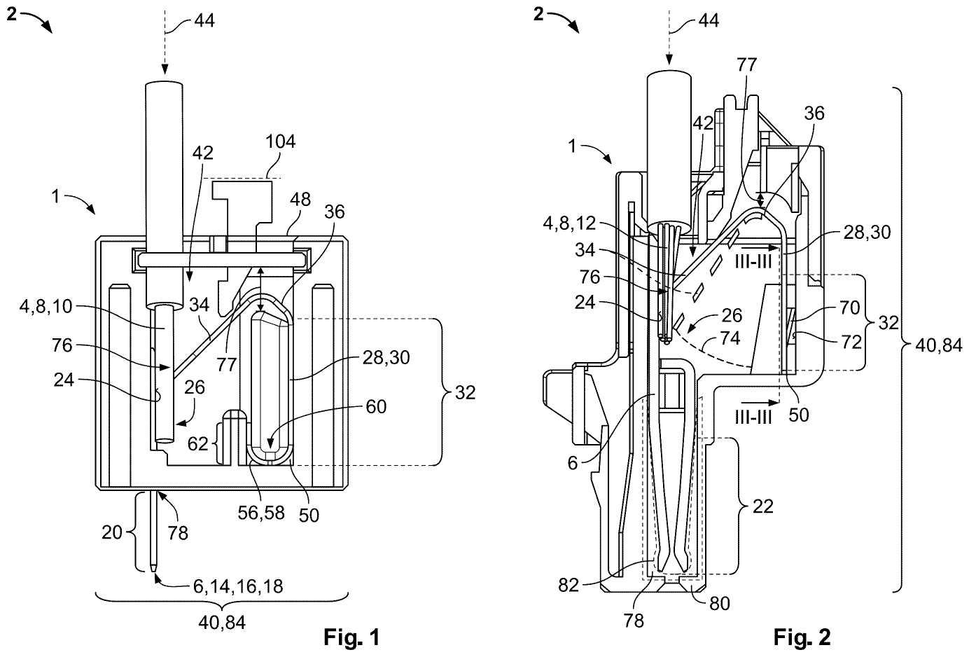

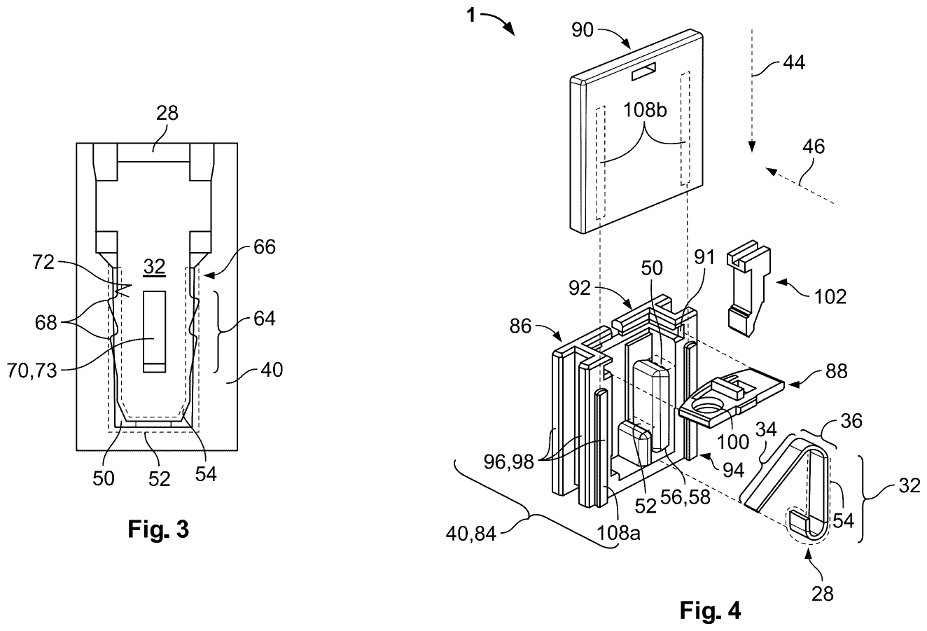

In the following, the schematic structure of a clamp retainer 1 and an electric connector 2 will be explained with reference to FIGS. 1 to 14. Furthermore, a method for manufacturing such a clamp retainer 1 will be explained with reference to FIGS. 4 to 14.

The clamp retainer 1 may be used in the electric connector 2. The electric connector 2 may be used in an automation system (not shown) for connecting system components (not shown) as a means for transmitting electrical currents and/or signals. In particular, the electric connector 2 may be used as a means for wire termination.

Besides the clamp retainer 1, the electric connector 2 may comprise at least one electrical conductor 4 as well as at least one contact element 6. In FIG. 1, one such electrical conductor 4 is shown. The electrical conductor 4 may be a lead wire 8, for example a solid wire 10 with a cross-sectional area of e.g., 4 mm\hat{ }2. According to an alternative embodiment, the electrical conductor 4 may be a stranded wire 12 (see FIG. 2). A wire size of the stranded wire 12 may range between 0.2 mm\hat{ }2 and 2.5 mm\hat{ }2. Other possible types of the electrical conductor include conductive braids, tubes and tapes as well as busbars. The electrical conductor 4 may be made of copper, aluminum or other metals.

Further, one exemplary contact element 6 is shown in FIG. 1. The contact element 6 may be, for example, a contact rail 14 comprising a metal strip 16. As such, the contact element 6 may be a stamped and bent part 18 made of copper, aluminum or other metals. A tab-shaped section 20 of the contact element 6 may extend out of the clamp retainer 1. Alternatively, the contact element 6 may comprise a fork-shaped section 22 (see FIG. 2) configured to be mated with a tab-shaped section of a mating contact in a mating connector (not shown).

Moreover, the contact element 6 may comprise a contacting surface 24 that is configured to contact the electrical conductor 4 when the latter is inserted into the clamp retainer 1. For this purpose, the contacting surface 24 may be exposed to the electrical conductor 4 within the clamp retainer 1. As will be described in further detail below, the electric connector 2 allows an electrical connection to be established between the contact element 6 and the electrical conductor 4 simply by inserting a bare end 26 of the electrical conductor 4 into the clamp retainer 1. Although not shown in the figures, the electrical conductor 4 may lead to one system component, while the contact element 6 can be mated to the mating contact of the mating connector having conductors leading to a different system component.

In order to improve the contacting force acting between the contact element 6 and the electrical conductor 4, the clamp retainer 1 comprises at least one clamping spring 28 for clamping the electrical conductor 4 and thereby pressing the electrical conductor 4 against the contact element 6. In the absence of the electrical conductor 4, the at least one clamping spring 28 presses the contact element 6 (see FIG. 2).

In FIG. 1, one exemplary clamping spring 28 is shown. The clamping spring 28 may be a single-piece, continuous metal component 30 manufactured by stamping and/or bending a sheet of spring steel or other suitable metal. Alternatively, the clamping spring 28 may also be made of non-metallic materials with sufficient elasticity.

The clamping spring 28 comprises a fixing portion 32, a clamping portion 34 and an intermediate portion 36, wherein the intermediate portion 36 joints together the clamping portion 34 with the fixing portion 32. As can be seen in FIG. 2, the clamping spring 28 may be substantially V-shaped with two legs 38 formed by the clamping portion 34 and the fixing portion 32, respectively. The intermediate portion 36 may extend between the clamping portion 34 and the fixing portion 32 in a curved manner. In particular, the intermediate portion 36 may be curved away from the clamping portion 34 and the fixing portion 32. Optionally, the clamping spring 28 may be bent outwardly only, without any inward bents. In other words, the bending direction of all bents of the clamping spring 28 may be the same.

The clamp retainer 1 further comprises an insulation housing 40 defining at least one receptacle 42 for inserting the electrical conductor 4 along an insertion direction 44. The at least one receptacle 42 may extend through the insulation housing 40 in the insertion direction 44 and define a hollow interior of the insulation housing 40. At a housing opening 48, the at least one receptacle 42 may be accessible from the outside of the insulation housing 40.

The fixing portion 32 is held directly by the insulation housing 40. That is, no intermediate holding structures such as cages and frames that are common in known retainers, is used in the clamp retainer 1. Rather, the fixing portion 32 and the insulation housing 40 are at least sectionally in immediate contact with no other parts in between them.

For this purpose, the insulation housing 40 may comprise at least one holding slot 50 for holding the fixing portion 32 of the clamping spring 28. In particular, the fixing portion 32 may be inserted into the at least one holding slot 50. Similar to the at least one receptacle 42, the at least one holding slot 50 may extend through the insulation housing 40. In particular, the at least one holding slot 50 may lead into the at least one receptacle 42. If multiple clamping springs 28 are provided, the insulation housing 40 may comprise one holding slot 50 of each clamping spring 28 (see FIG. 8). Alternatively, one or more clamping springs 28 may share the same holding slot 50.

An inner contour 52 of the at least one holding slot 50 may be complementary at least sectionally with an outer contour 54 of the fixing portion 32 of the clamping spring 34. Herein, the contours are complementary if they coincide or correspond to each other within a margin of +/−10%. In other words, the fixing portion 32 at least fills out 90% of the at least one holding slot 50 or is oversized up to not more than 110% of the at least one holding slot 50.

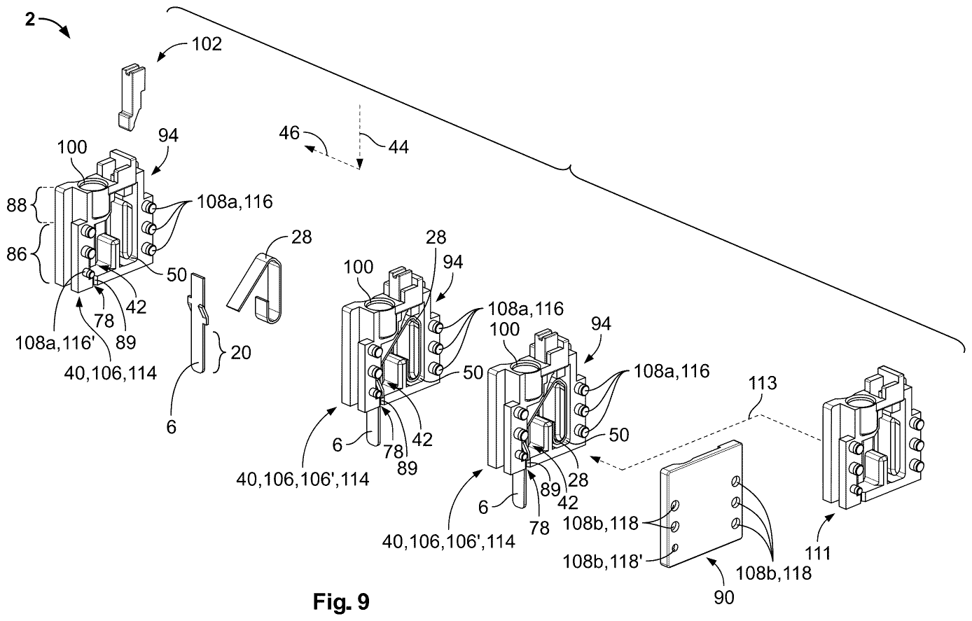

As can be seen in FIGS. 4 and 9, the fixing portion 32 may be inserted into the at least one holding slot 50 perpendicularly to the insertion direction 44. For this purpose, the at least one holding slot 50 may be accessible from a direction 46 perpendicular to the insertion direction 44. Further, the at least one holding slot 50 may comprise an undercut 56 in the insertion direction 44. In other words, the at least one holding slot 50 may extend through the insulation housing 40 perpendicularly to the insertion direction 44 and form a recess 58 in the insulation housing 40 that is inaccessible using a straight tool (not shown) directed in the insertion direction 44. By insertion perpendicular to the insertion direction 44, however, the fixing portion 32 can enter into the undercut 56. There, the fixing portion 32 can rest against the insulation housing 40 and withstand a force pulling it out of the at least one holding slot 50 against the insertion direction 44.

This allows the fixing portion 32 to engage in a reliable form-fit connection 60 with the insulation housing 40. For example, the fixing portion 32 may comprise a hook-shaped section 62 configured to engage in said form-fit connection 60. At the hook-shaped section 62, the fixing portion 32 may be bent around and may extend in parallel with another section of the fixing portion 32 adjacent to the hook-shaped section 62. As can be seen in FIGS. 4 and 9, this substantially results in the fixing portion 32 having a shape similar to the letter “J”.

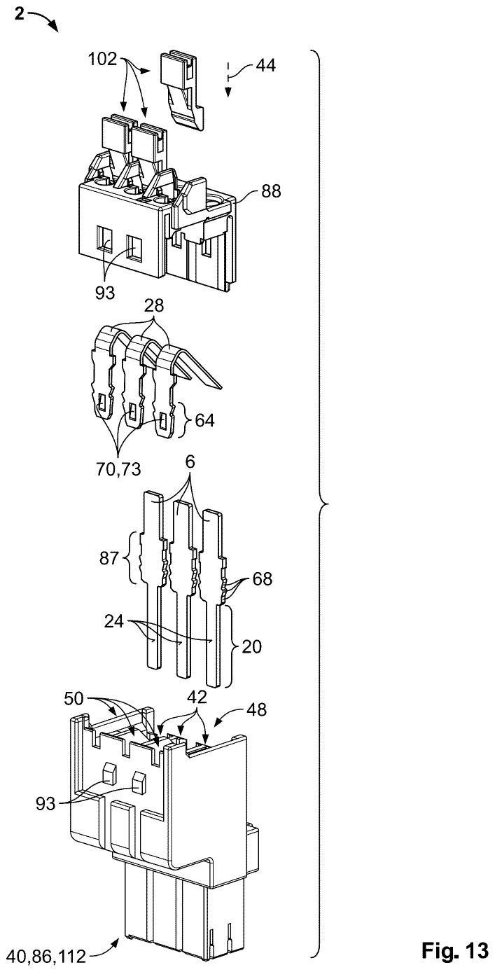

Alternatively, the fixing portion 32 may be substantially straight as shown in FIGS. 8 and 13. Moreover, the fixing portion 32 may be inserted into the at least one holding slot 50 along the insertion direction 44. For this purpose, the at least one holding slot 50 may be accessible from the insertion direction 44. Still, the fixing portion 32 needs to be configured to withstand a force pulling it out of the at least one holding slot 50 against the insertion direction 44.

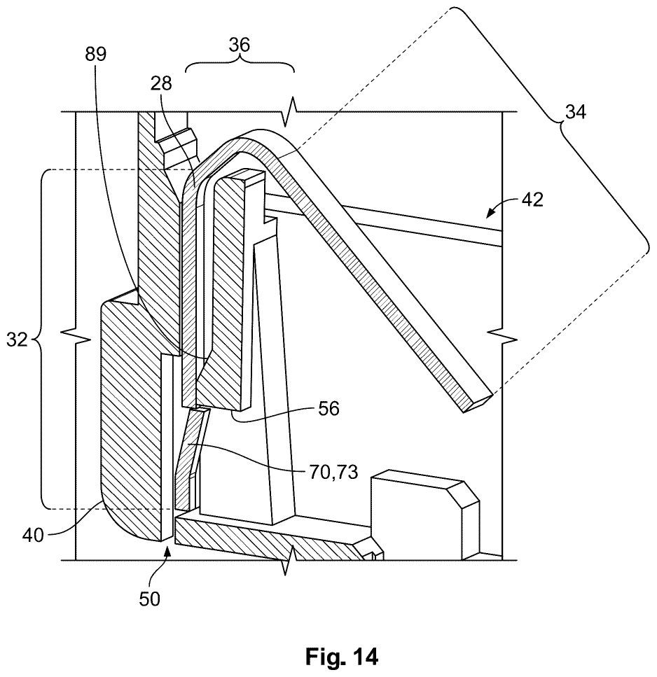

In this case, the fixing portion 32 may comprise a barbed section 64 configured to engage in an interference-fit connection 66 with the insulation housing 40. For example, the barbed section 64 may comprise teeth 68 and/or latching features 70 that engage with an inner surface 72 of the at least one holding slot 50, when the barbed section 64 is inserted there. As can be seen in FIG. 14, the latching feature 70 may be cut out and/or bent out from the rest of the fixing portion 32 as a flap 73. In particular, the flap 73 may be bent away from the clamping portion 34 (see FIG. 2) or towards the clamping portion 34 (see FIG. 14).

Upon insertion of the fixing portion 32 into its corresponding holding slot 50, the flap 73 may be squeezed to fit into the holding slot 50. Once the flap 73 reaches the undercut 56 of the holding slot 50, an elastic restoring force causes the flap 73 to expand into the undercut 56 and thus latch into engagement with the insulation housing 40 (see FIG. 14).

The clamping spring 28 may be configured to automatically clamp the electrical conductor 4 upon its insertion into the at least one receptacle 42. For this purpose, the clamping portion 34 is deflectable towards the fixing portion 32. In particular, the clamping portion 34 may be deflected by the bare end 26 of the electrical conductor 4. This can be seen in FIG. 1.

Optionally, a trigger mechanism (not shown) may be provided that catches the clamping portion 34 in its deflected state. Upon insertion of the electrical conductor 4 and/or activation of a button (not shown), the trigger mechanism may release the clamping portion 34 to spring under its restoring force away from the fixing portion 32. Thereby, the clamping spring 28 may also be configured to automatically clamp the electrical conductor 4.

In the embodiments shown in FIGS. 1 and 2, no trigger mechanism is provided. Instead, the clamping portion 34 may be freely deflectable towards the fixing portion 32 into abutment with the insulation housing 40 and away from the fixing portion 32. In other words, the clamping portion 34 may be deflected towards the fixing portion 32 until abutment with the insulation housing 40 and back without its movement path 74 being obstructed, in particular not by any trigger mechanism.

Moreover, the clamping spring 28 may be configured to stem against the inserted electrical conductor 4 and prevent the electrical conductor 4 from being pulled out contrary to the insertion direction 44. For this purpose, the clamping portion 34 may be substantially straight and/or may extend obliquely to the insertion direction 44 into the at least one receptacle 42. For example, the clamping portion 34 may be inclined by an angle of 30° to 50° relative to the insertion direction 44. This configuration allows the electrical conductor 4 to be easily inserted, i.e. moved relative to the clamping portion 34 in the insertion direction 44.

On the other hand, if the electrical conductor 4 is pulled out, i.e. moved relative to the clamping portion 34 against the insertion direction 44, the clamping portion 34 stems against the electrical conductor 4. This impedes the pull-out movement. In other words, the clamping portion 34 may be configured to engage in a self-locking, mechanical connection 76 with the electrical conductor 4. Due to the self-locking nature of this engagement, the electrical conductor 4 can simply be inserted into the at least one receptacle 42 with minimal effort.

With the clamping portion 34 stemming against the electrical conductor 4, vibrations acting on the electrical conductor 4 will be transmitted via the clamping spring 28 onto the insulation housing 40 and the rest of the clamp retainer 1. Herein, the intermediate portion 36 can act as a compensator. For this purpose, the intermediate portion 36 is spaced apart from the insulation housing 40 in the insertion direction 44. Thereby, the clamping spring 28 is sectionally cantilevered and provided with a certain clearance 77, in which the intermediate portion 36 can move without being obstructed by the insulation housing 40. Thus, the clamping spring 28 can better absorb vibrations as well as other unwanted movements effecting the clamp retainer 1, while offering the same clamping force as springs in known retainers. In other words, the clamping spring 28 is equally strong, but less rigid compared to known retainers where the spring rests against the housing, cage or frame in the insertion direction 44. This improves the performance and reliability of the clamp retainer 1.

Similar to the clamping spring 28, the contact element 6 may be directly held by the insulation housing 40 of the clamp retainer 1. For this purpose, the insulation housing 40 may comprise at least one rail slot 78 configured to receive the contact element 6. In particular, an inner contour 80 of the at least one rail slot 78 may be complementary at least sectionally with an outer contour 82 of the contact element 6.

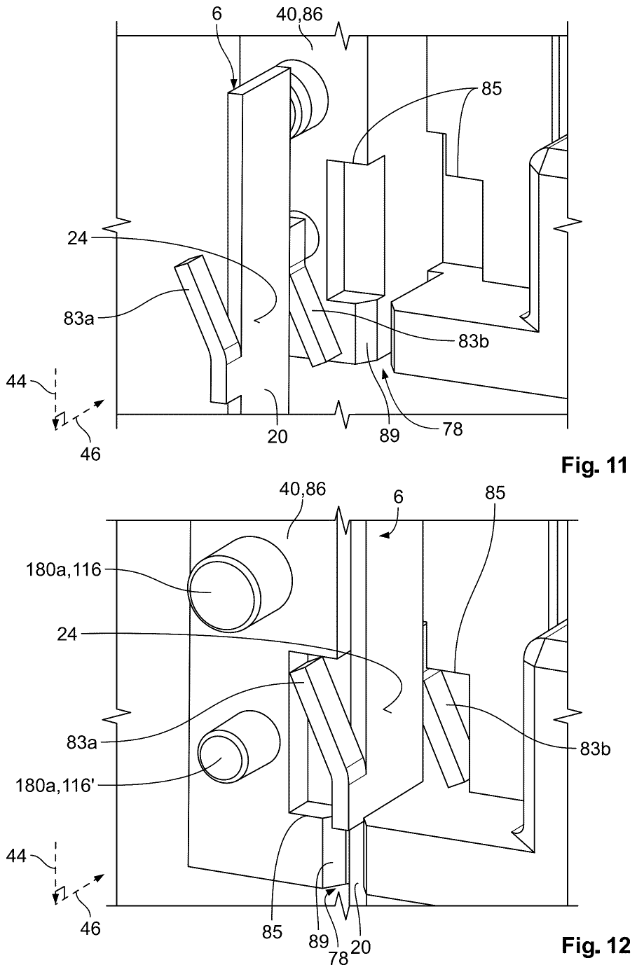

As can be seen in FIGS. 11 and 12, the contact element 6 may comprise oblique holding prongs 83a, 83b that are bent away from the rest of the contact element 6. For example, one holding prong 83a may be connected adjacent to the contacting surface 24 of the contact element 6 with its proximal end, while its distal end points away from the tab-shaped section 20. Another holding prong 83b may likewise be connected with its proximal end adjacent to the contacting surface 24, but have its distal end pointing in the opposite direction. In other words, the holding prongs 83a, 83b may be arranged in a Z-shaped formation.

In this embodiment, the at least one rail slot 78 may be accessible from the direction 46 perpendicular to the insertion direction 44. Further, the at least one rail slot 78 may comprise holding pockets 85 to receive the respective holding prongs 83a, 83b of the contact element 6. Those holding pockets 85 may be inaccessible for a straight tool (not shown) directed in the insertion direction 44. However, by inserting the contact element 6 perpendicular to the insertion direction 44, the holding prongs 83a, 83b can enter into the corresponding holding pockets 85 (see FIG. 12). There, the holding prongs 83a, 83b can rest against the insulation housing 40 and withstand a force pulling out the contact element 6 from the at least one rail slot 78 against the insertion direction 44.

According to an alternative embodiment shown in FIG. 13, the contact element 6 may comprise a serrated section 87 configured to engage in an interference-fit connection 66 with the insulation housing 40. Similar to the barbed section 64 of the clamping spring 28, the serrated section 87 may comprise teeth 68 and/or latching features (not shown) that engage with an inner surface of the at least one rail slot 78, when the serrated section 87 is inserted there.

The clamping spring 28 and the contact element 6 may both be inserted into their respective slot (i.e. holding slot 50 or rail slot 78) along the insertion direction 44 (see FIGS. 8 and 13) or along the direction 46 perpendicular to the insertion direction 44 (see FIG. 9). In particular, the slots 50, 78 may serve as insertion guides during said insertion and comprise corresponding lead-in chamfers 89. Alternatively, the clamping spring 28 and the contact element 6 may be inserted into their respective slot from opposite directions or mutually perpendicular directions.

Optionally, the at least one rail slot 78 may be arranged opposite the at least one holding slot 50 with respect to the at least one receptacle 42. Accordingly, the electrical conductor 4 may be inserted into the at least one receptacle 42 of the insulation housing 40 and clamped between the contact element 6 and the clamping spring 28. In this clamped state, the clamping portion 34 of the clamping spring 28 may extend obliquely towards the electrical conductor 4 in order to achieve the above-mentioned self-locking, mechanical connection 76.

The insulation housing 40 may be made of a non-conductive material, in particular a material with a conductivity of less than 10\hat{ }8 S·cm−1 and/or a specific resistance over 10\hat{ }8 Ω·cm. For example, the insulation housing 40 may be made of plastic, ceramic and/or other non-metallic materials. In order to provide the clamp retainer 1 with an improved structural stability, the insulation housing 40 may comprise at least one reinforcement structure 96. For example, the at least one reinforcement structure 96 may be a stiffening rib 98 extending along the insertion direction 44 and/or along a lateral side 94. Herein, the lateral side 94 may be a side extending parallel to the insertion direction 44.

Moreover, the insulation housing 40 may be a multi-part assembly 84. In particular, the insulation housing 40 may comprise at least one housing element 86 forming the at least one receptacle 42 and the at least one holding slot 50. Further, the insulation housing 40 may comprise at least one cover element 88 and/or a side plate 90 each attachable to the at least one housing element 86.

In the embodiment shown in FIG. 4, the housing element 86 may have a substantially cuboid shape that is open from the insertion direction 44 and from the direction 46 perpendicular to the insertion direction 44. In other words, an outer wall of the cuboid shape may be omitted on a top side 92 and/or on the lateral side 94 of the housing element 86. Herein, the top side 92 may be a side extending perpendicular to the insertion direction 44.

The at least one cover element 88 may be used to close the top side 92, in particular, the above-mentioned housing opening 48. For example, an outer edge of the at least one cover element 88 may be at least sectionally received in a groove 91 extending around the housing opening 48 (see FIG. 4). Alternatively, the at least one cover element 88 may be attached to the housing element 86 by means of mutually complementary latching features 93 (see FIG. 8). According to another alternative embodiment, the housing element 86 and cover element 88 may be monolithically formed to an integral component 114 as shown in FIG. 9.

On the other hand, the side plate 90 may be used for closing the open lateral side 94 of the housing element 86. In other words, the at least one cover element 88 may replace the omitted outer wall on the top side 92, while the side plate 90 may replace the omitted outer wall on the lateral side 94. Thus, the at least one clamping spring 28 can be first fixed in the at least one holding slot 50, whereafter the at least one cover element 88 and/or the side plate 90 can be attached to shut the insulation housing 40.

Optionally, the at least one cover element 88 may be aligned with the at least one clamping spring 28 in the insertion direction 44 and with the side plate 90 in the direction 46 perpendicular to the insertion direction 44. In particular, the at least one cover element 88 may cover the at least one clamping spring 28 from the insertion direction 44, while the side plate 90 retains the at least one cover element 88 in the groove 91.

For inserting the electrical conductor 4, the at least one cover element 88 may comprise an opening 100 leading into the at least one receptacle 42. In order to cantilever the at least one clamping spring 28 and provide the clearance 77, the at least one cover element 88 may be spaced apart from intermediate portion 36 of the at least one clamping spring 28.

As can be seen in FIGS. 1 and 2, the clamp retainer 1 may comprise at least one push-button element 102 slidably held by the at least one cover element 88. The at least one push-button element 102 serves to facilitate the operation of the clamp retainer 1. For example, the at least one push-button element 102 may be movable into a release position, where the at least one push-button element 102 is configured to deflect the clamping portion 34 of the at least one clamping spring 28 away from the clamped electrical conductor 4. This way, the self-locking mechanical connection 76 can be disengaged and removal of the electrical conductor 4 requires less effort.

Likewise, the at least one push-button element 102 may be configured to deflect, in the release position, the clamping portion 34 towards the corresponding fixing portion 32 and thus make room for the electrical conductor 4 in the at least one receptacle 42. Moreover, the at least one push-button element 102 may be movable between the release position and an engagement position 104. In the engagement position 104, the at least one push-button element 102 allows the clamping portion 34 to clamp the electrical conductor 4. Optionally, the at least one push-button element 102 may be pushed by the at least one clamping spring 28 out of the release position and into the engagement position 104. Thereby, the electrical conductor 4 can be clamped by simply letting go of the at least one push-button element 102.

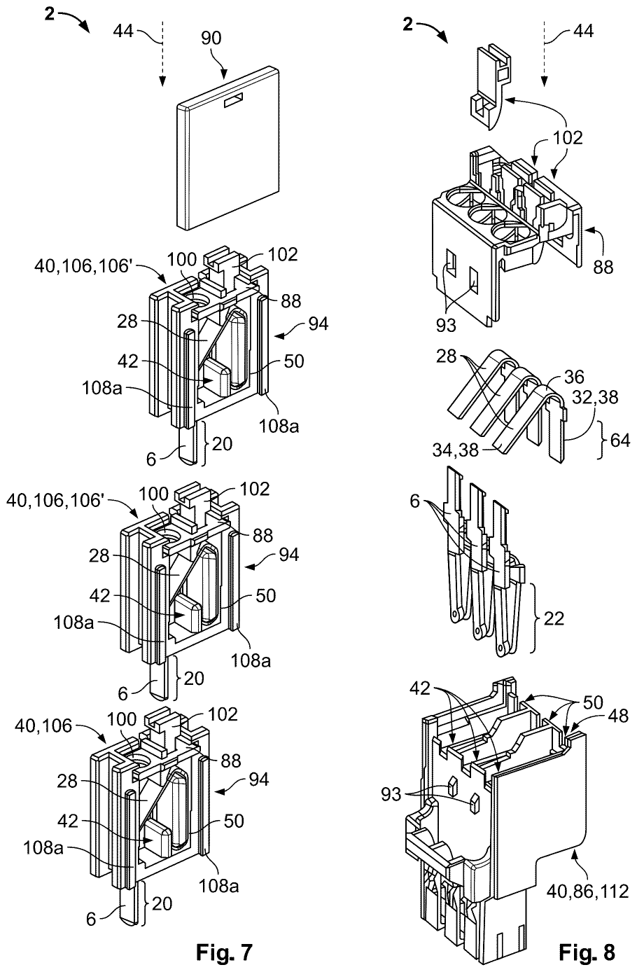

As shown in FIG. 7, the insulation housing 40 may comprise a plurality of modular housing elements 106 each forming one receptacle 42 for inserting a different electrical conductor. The modular housing elements 106 may be stackable in a sense that they are configured to be stacked onto each other or next to each other. This way, the clamp retainer 1 can be used not only in electric connectors 2 with multiple electrical conductors 4, but also with varying numbers of electrical conductors simply be stacking the required number of modular housing elements 106.

Each of the modular housing elements 106 may be configured analogous to the housing element 86 described above with respect to FIGS. 4 to 6. Optionally, each of the modular housing elements 106 may comprise at least one attachment feature 108a on the lateral side 94 thereof and at least one counterpart attachment feature 108b that is complementary to the at least one attachment feature 108a and arranged opposite of the lateral side 94. For increased stability and redundancy, two attachment features 108a may be provided on the lateral side 94 and two counterpart attachment features 108b may be correspondingly arranged opposite of the lateral side 94. Of course, the number of attachment features 108a and counterpart attachment features 108b can be increased even further, if required by a specific application. For example, in the embodiment of FIG. 9, each modular housing element 106 comprises six attachment features 108a and six counterpart attachment features 108b. Each attachment feature 108a may be configured to engage in a form-fit connection 110 with the corresponding counterpart attachment feature 108b of an adjacent modular housing element 106′.

Thus, the modular housing elements 106 may be stacked adjacent to each other with their open top sides 92 and/or open lateral sides 94 facing in the same direction, respectively. In the embodiment shown in FIG. 7, a separate cover element 88 is provided for each modular housing element 106 and utilized for closing the open top sides 92 of the modular housing elements 106. Alternatively, a common cover element for all modular housing elements 106 can be provided. Another alternative is to have the cover elements 88 monolithically formed with each modular housing element 106 as shown in FIG. 9.

The side plate 90 is used to close the open lateral side 94 of the outermost modular housing element 106′. The open lateral sides 94 of the remaining modular housing elements 106 are closed by their respective neighboring housing elements 106′. For the purpose of its attachment, the side plate 90 may comprise one or more counterpart attachment features 108b like each modular housing element 106 has. The counterpart attachment features 108b of the side plate 90 may be configured to engage in the form-fit connection 110 with the corresponding attachment features 108a of the outermost modular housing element 106′. As an alternative to the side plate 90, a dummy housing 111 that is configured identical to the modular housing elements 106, but left empty (i.e. without any contact element 6, clamping spring 28 or push-button element 102) may be used to close the open lateral side 94 of the outermost modular housing element 106′. This is indicated in FIG. 9 by the dashed arrow 113.

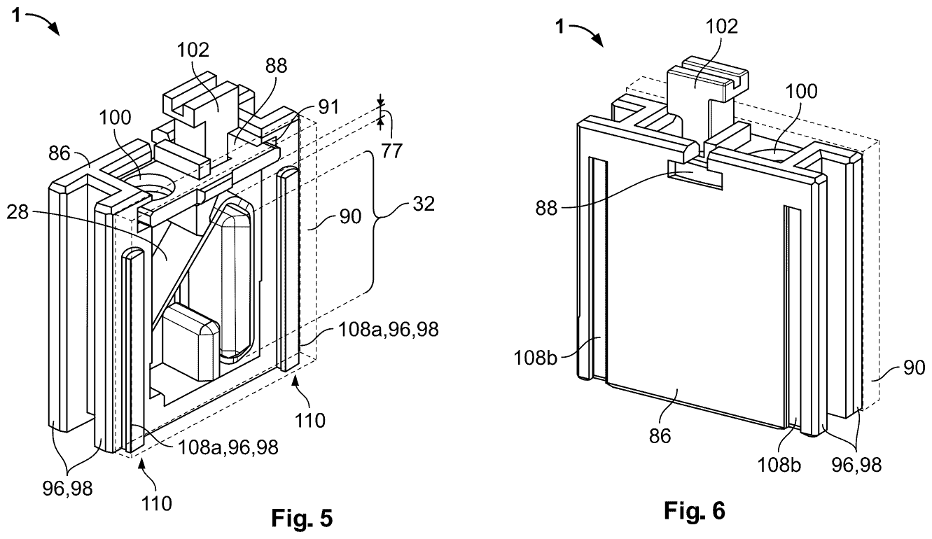

As can be seen in FIG. 5, the at least one attachment feature 108a may extend along the insertion direction 44, along the direction 46 perpendicular to the insertion direction 44 and/or along the lateral side 94. Therefore, the at least one attachment feature 108a may be embodied by the stiffening rib 98 and hence function as the at least one reinforcement structure 96. In other words, the at least one reinforcement structure 96 may be shaped complementary to the at least one counterpart attachment feature 108b. Thus, the at least one reinforcement structure 96 and the at least one counterpart attachment feature 108b may be configured to engage in the above-mentioned form-fit connection 110.

Alternatively, each attachment feature 108a may be embodied by a cylindrical nob 116 that projects from the lateral side 94 of the respective modular housing element 106. For example, the cylindrical nob 116 may extend in the direction 46 perpendicular to the insertion direction 44. Accordingly, each counterpart attachment feature 108b may be embodied by a round hole 118 configured to engage in a press-fit connection with the cylindrical nob 116. If multiple attachment features 108a and counterpart attachment features 108b are provided, a coding function can be achieved by having at least one pair of cylindrical nob 116′ and round hole 118′ that is sized differently from the other cylindrical nobs 116 and round holes 118 (see FIG. 9). Of course, the nobs 116 and holes 118 do not have to be cylindrical and round, respectively, as long they have mutually complementary shapes that allow their press-fit connection.

According to an alternative embodiment shown in FIG. 8, the insulation housing 40 may comprise a single integral housing element 112 forming a plurality of receptacles 42 each for inserting a different electrical conductor. Likewise, a plurality of push-button elements 102 may be provided for each of the receptacles 42 (see FIGS. 8 and 13).

The method for manufacturing the clamp retainer 1 comprises the step of fixing the at least one clamping spring 28 at its fixing portion 32 directly to the insulation housing 40 such that the clamping portion 34 is deflectable towards the fixing portion 32 and the intermediate portion 36 is spaced apart from the insulation housing 40 in the insertion direction 44. For example, the at least one clamping spring 28 may be placed into the insulation housing 40 along the insertion direction 44 (see FIGS. 8 and 13). Alternatively, the at least one clamping spring 28 may be placed into the insulation housing 40 perpendicular to the insertion direction 44 (see FIGS. 4 and 9). Further alternatively, the at least one clamping spring 28 may be over-molded with the insulation housing. In any case, the at least one clamping spring 28 is surrounded by the insulation housing 40 and directly held by it as well.

Similarly, the at least one contact element 6 may be placed into the insulation housing 40 along the insertion direction 44 (see FIGS. 8 and 13). Alternatively, the at least one contact element 6 may be placed into the insulation housing 40 perpendicular to the insertion direction 44 (see FIGS. 4 and 9).

If the at least one cover element 88 is provided separately, it may be attached to the housing element 86 (i.e. the modular housing element 106 or the integral housing element 112). Prior to or after attachment of the at least one cover element 88, the at least one push-button element 102 may be placed in the corresponding cover element 88 (see FIG. 8).

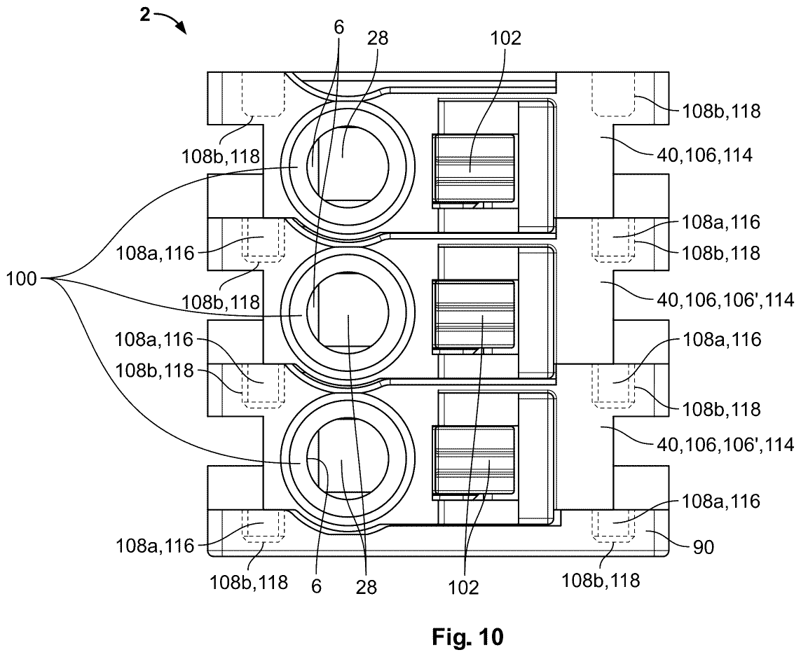

If the insulation housing 40 comprises multiple modular housing elements 106, these modular housing elements 106 may be stacked after placement of the at least one clamping spring 28 and the at least one contact element 6 as well as after attachment of the at least one cover element 88. Depending on the design of the attachment features 108a and counterpart attachment features 108b, the modular housing elements 106 may be stacked along the insertion direction 44 (see FIG. 7) or along the direction 46 perpendicular to the insertion direction 44 (see FIG. 9). Lastly, the open lateral side 94 of the outermost modular housing element 106′ is closed using the side plate 90 or the dummy housing 111 to arrive at the assembled clamp retainer 1 (see FIG. 10).

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Clamp retainer for an electric connector, the clamp retainer comprising:
an insulation housing defining at least one receptacle for inserting an electrical conductor along an insertion direction, and
at least one clamping spring for clamping the electrical conductor upon insertion into the at least one receptacle,
wherein the at least one clamping spring comprises a fixing portion, a clamping portion and an intermediate portion, wherein the fixing portion is held directly by the insulation housing, wherein the clamping portion is deflectable towards the fixing portion, wherein the clamping portion and the fixing portion are jointed by the intermediate portion, and wherein the intermediate portion is spaced apart from the insulation housing in the insertion direction.

2. Clamp retainer according to claim 1, wherein the insulation housing comprises at least one holding slot for holding the fixing portion of the at least one clamping spring, wherein an inner contour of the at least one holding slot is complementary at least sectionally with an outer contour of the fixing portion of the at least one clamping spring.

3. Clamp retainer according to claim 2, wherein the at least one holding slot is accessible from the insertion direction and/or a direction perpendicular to the insertion direction.

4. Clamp retainer according to claim 1, wherein the fixing portion of the at least one clamping spring comprises a barbed section configured to engage in an interference-fit connection with the insulation housing.

5. Clamp retainer according to claim 1, wherein the fixing portion of the at least one clamping spring comprises a hook-shaped section configured to engage in a form-fit connection with the insulation housing.

6. Clamp retainer according to claim 1, wherein the insulation housing comprises at least one housing element forming the at least one receptacle and at least one cover element attachable to the at least one housing element, wherein the at least one cover element is aligned with the at least one clamping spring in the insertion direction.

7. Clamp retainer according to claim 6, wherein the clamp retainer comprises at least one pushbutton element slidably held by the at least one cover element, wherein the at least one pushbutton element is movable into a release position, where the at least one pushbutton element is configured to deflect the clamping portion of the at least one clamping spring.

8. Clamp retainer according to claim 6, wherein the insulation housing comprises a single integral housing element forming a plurality of receptacles each for inserting a different electrical conductor.

9. Clamp retainer according to claim 6, wherein the insulation housing comprises a plurality of modular housing elements each forming a receptacle for inserting a different electrical conductor, and wherein the modular housing elements are stackable.

10. Clamp retainer according to claim 9, wherein each of the modular housing elements comprises:
at least one attachment feature on a lateral side thereof and
at least one counterpart attachment feature that is complementary to the at least one attachment feature and arranged opposite of the lateral side.

11. Clamp retainer according to claim 10, wherein the insulation housing comprises at least one reinforcement structure extending along the insertion direction, the at least one reinforcement structure forming the least one attachment feature.

12. Clamp retainer according to claim 1, wherein the insulation housing comprises at least one reinforcement structure extending along the insertion direction.

13. Electric connector comprising:
a clamp retainer, at least one contact element and at least one electrical conductor;
the clamp retainer including an insulation housing defining at least one receptacle for inserting an electrical conductor along an insertion direction, and at least one clamping spring for clamping the electrical conductor upon insertion into the at least one receptacle;
wherein the at least one clamping spring comprises a fixing portion, a clamping portion and an intermediate portion, wherein the fixing portion is held directly by the insulation housing, wherein the clamping portion is deflectable towards the fixing portion, wherein the clamping portion and the fixing portion are jointed by the intermediate portion, and wherein the intermediate portion is spaced apart from the insulation housing in the insertion direction; and
wherein the at least one electrical conductor is inserted into the at least one receptacle of the insulation housing and clamped between the at least one contact element and the at least one clamping spring.

14. Electric connector according to claim 13, wherein the insulation housing comprises at least one holding slot for holding the fixing portion of the at least one clamping spring, wherein an inner contour of the at least one holding slot is complementary at least sectionally with an outer contour of the fixing portion of the at least one clamping spring.

15. Electric connector according to claim 13, wherein the fixing portion of the at least one clamping spring comprises a barbed section configured to engage in an interference-fit connection with the insulation housing.

16. Electric connector according to claim 13, wherein the fixing portion of the at least one clamping spring comprises a hook-shaped section configured to engage in a form-fit connection with the insulation housing.

17. Electric connector according to claim 13, wherein the insulation housing comprises at least one housing element forming the at least one receptacle and at least one cover element attachable to the at least one housing element, wherein the at least one cover element is aligned with the at least one clamping spring in the insertion direction.

18. Electric connector according to claim 13, wherein the insulation housing comprises at least one reinforcement structure extending along the insertion direction.

19. Method for manufacturing a clamp retainer for clamping an electrical conductor of an electric connector, wherein the clamp retainer is manufactured from:
at least one clamping spring comprising a fixing portion and a clamping portion jointed by an intermediate portion; and
an insulation housing comprising at least one receptacle for inserting the electrical conductor along an insertion direction,
the method comprising the step of:
fixing the at least one clamping spring at its fixing portion directly to the insulation housing such that the clamping portion is deflectable towards the fixing portion and the intermediate portion is spaced apart from the insulation housing in the insertion direction.

20. Method according to claim 19, wherein the at least one clamping spring is placed into the insulation housing along the insertion direction or perpendicular to the insertion direction.
